(19) United States
(12) Patent Application Publication
(10) Pub. No.: US 2025/0225431 A1
(43) Pub. Date: Jul. 10, 2025

(54) EFFICIENT ATTENTION MECHANISMS FOR MACHINE LEARNING APPLICATIONS

(71) Applicant: QUALCOMM Incorporated, San Diego, CA (US)

(72) Inventors: Jamie Menjay Lin, San Diego, CA (US); Jisoo Jeong, San Diego, CA (US); Jian Shen, San Diego, CA (US); Fatih Murat Porikli, San Diego, CA (US); Kai Wang, San Diego, CA (US)

(21) Appl. No.: 18/407,302

(22) Filed: Jan. 8, 2024

(51) Int. Cl. G06N 20/00

(52) U.S. Cl. CPC G06N 20/00

(57) ABSTRACT

This disclosure provides systems, methods, and devices for machine learning techniques that support attention mechanisms. In one aspect, a method is provided that includes receiving encoded input data that includes query values and key values. Differences between the query and key values may be determined, and these differences may be used to determine attention weights. For example, attention weights may be determined based on L1 and/or L2 differences between the values. In certain aspects, the attention weights may be determined with reduced multiplication steps, such as using a lookup table. Output data may then be determined based on the attention weights and the encoded input data. Other aspects and features are also claimed and described.

### TECHNICAL FIELD

Aspects of the present disclosure relate generally to machine learning techniques, and more particularly, to methods and systems suitable for determining attention mechanisms for use by machine learning models.

### INTRODUCTION

Machine learning techniques encompass a diverse array of computational methodologies designed to enable systems to learn from and make predictions or decisions based on data. These techniques typically involve the construction of models, algorithms, or neural network architectures that can infer patterns, trends, or structures within large datasets without explicit programming for each task. Machine learning techniques include supervised learning, where models are trained using labeled datasets; unsupervised learning, which involves the identification of patterns in unlabeled data; semi-supervised learning, which combines both labeled and unlabeled data; and reinforcement learning, where models learn optimal behaviors through trial and error interactions with an environment.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one embodiment, a method is provided that includes receiving encoded input data for a machine learning model, wherein the encoded input data includes query values and key values; determining differences between corresponding elements of the query values and the key values; determining attention weights for use by the machine learning model based on the differences; and determining, by the machine learning model, output data based on the encoded input data and the attention weights.

An additional embodiment provides a system including at least one processor, comprising at least one machine learning processor; and a memory storing instructions which, when executed by the at least one processor, cause the at least one processor to receive encoded input data for a machine learning model, wherein the encoded input data includes query values and key values; determine, by the at least one machine learning processor, differences between corresponding elements of the query values and the key values; determine, by the at least one machine learning processor, attention weights for use by the machine learning model based on the differences; and determine, by the machine learning model, output data based on the encoded input data and the attention weights.

A further embodiment includes a non-transitory, computer-readable medium storing instructions which, when executed by a processor, cause the processor to receive encoded input data for a machine learning model, wherein the encoded input data includes query values and key values; determine differences between corresponding elements of the query values and the key values; determine attention weights for use by the machine learning model based on the differences; and determine, by the machine learning model, output data based on the encoded input data and the attention weights.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example image processing configuration for a vehicle according to one or more aspects of the disclosure.

FIG. 2 is a block diagram illustrating details of an example wireless communication system according to one or more aspects.

FIG. 3 is a block diagram illustrating a system for determining attention-based machine learning outputs according to one or more aspects of the disclosure.

FIG. 4 is a flow chart illustrating an example method for determining attention-based machine learning outputs according to one or more aspects of the disclosure.

FIG. 5 depicts graphs of lookup table values according to one aspect of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support efficient determination of attention weights for attention-based machine learning (ML) models. Attention-based ML models are types of models configured to simulate a selective focus mechanism akin to human cognition. Unlike other types of ML models that treat each part of the data uniformly, attention-enabled models may be configured to dynamically highlight and allocate computational resources to pertinent elements of the input data. Such models may exhibit improved performance for applications that require intricate understanding and processing of sequential or structured data. In the domain of natural language processing (NLP), for example, attention-based models improve the efficiency and quality of tasks such as machine translation and text summarization by focusing on relevant parts of the text while generating each word of the translation or summary. Similarly, in the realm of image recognition, attention facilitates the focus on salient features of an image, thereby improving object recognition and image captioning tasks. Example types of attention-based models include Recurrent Neural Networks (RNNs) with attention, where the model selectively revisits certain steps in the input sequence for refining the predictions or generation sequence. Convolutional Neural Networks (CNNs) with attention (such as Hadamard-attention CNNs), which may apply attention to different regions in an image or parts of data, adapting the level of focus according to the task's contextual needs (such as based on training). Transformers, a model architecture that relies entirely on attention mechanisms, dispensing with the sequential processing characteristic of RNNs and enabling parallelization and thus more efficient training with very large data sets.

Attention-based techniques may rely on Query-Key-Value (QKV) processes to determine attention weights that are applied to received input data in order to focus on pertinent aspects of the received input. Queries may represent a current element or piece of data that the model seeks to process or generate an output for. Keys may represent elements from the input data against which the query is compared to evaluate relevance. Values may represent elements of the input data which contain the substantive information that will be aggregated into the output once weighted by the attention scores. Received input data may be encoded or decomposed prior to processing into queries, keys, and values to enable further processing.

In an example process for determining attention weights for received input data, received input data may be processed to generate corresponding Q, K, and V matrices. This is commonly executed through learnable linear transformations, which are essentially matrix multiplications with added bias terms, allowing the model to project the raw input features into these conceptually differentiated abstractions. These matrices may have their parameters optimized during a training process for the model, enabling the model to learn how to effectively formulate queries, identify relevant keys, and compile valuable information.

The attention mechanism may then require the determination of a relevance of each key to the given query. The model may determine this by determining attention weights representative of the compatibility between a given key and the query (such as with higher weights indicating greater compatibility). Determining compatibility scores may typically employ significant matrix multiplication steps. For example, received input data may have N=H×W tokens or features. To compute token-wise vector correlations between queries and keys, conventional techniques may determine:

$${Diff}_{CONV , 1} = \frac{{\sum }_{i} {x}_{i} {y}_{i}}{norm}$$

For all i elements of the received feature vectors, and where X and Y represent components of individual vectors of matrices of queries and keys, and where Diff_{CONV} represents a conventional difference/correlation measure used to determine the attention weights between the vectors X and Y. The norm quantity may be computed using various techniques. For example, norm may be calculated based on L2 norms of X and Y as:

$${Diff}_{CONV , 2} = \frac{X}{{‖ X ‖}_{2}} \cdot \frac{Y}{{‖ Y ‖}_{2}} = \frac{{\sum }_{i} {x}_{i} {y}_{i}}{{‖ X ‖}_{2} {‖ Y ‖}_{2}}$$

$$where :$$

$${‖ X ‖}_{2} = \sqrt{{\sum }_{i} {x}_{i}^{2}}$$

$${‖ Y ‖}_{2} = \sqrt{{\sum }_{i} {y}_{i}^{2}}$$

These computations may be separately computed for all N tokens or features, requiring extensive multiplication steps.

The attention weights may then be normalized using a softmax equation. Continuing the previous example, to compute a token-wise correlation between softmax outputs and values for normalization, conventional techniques may determine:

$$softmax ( \frac{{QK}^{T}}{\sqrt{d}} ) = softmax ( \frac{{\sum }_{i , j} {q}_{i} {k}_{j}^{T}}{\sqrt{d}} )$$

where d is the length of the feature vectors, i is the number of entries in the query matrix, and j is the number of entries in the key matrix.

Based on the attention weights, the model may calculate a weighted sum of the value vectors to produce a context vector for each query. Each value vector is scaled by its attention weight, assembling an output that selectively emphasizes elements of the input that are most relevant to the given point of interest. The accumulated context vector may then further processed by the model (such as by the rest of a neural network) to generate the output.

To enable the above processing, input data may be segmented into discrete units known as tokens. Once tokenized, each token may then be embedded into a high-dimensional space, distilling the contents of the data token into feature vectors that encapsulate properties of the data. The contents of the embeddings/feature vectors may then be encoded to form the QKV matrices. In particular, each token may have a corresponding embedding and a corresponding query, key, and value in the QKV matrices. Additionally or alternatively, certain attention weights may correspond to more than one token (such as when considering a wider context), emphasizing the importance or relevance of corresponding token(s) in the formation of the model's output.

As can be seen in the equations above, conventional attention-based ML techniques require significant amounts of multiplication steps (such as matrix multiplication), both at training time and inference time. In particular, multiplication and/or division steps are required both to determine attention weights based on encoded input data and to normalize the attention weights in the softmax function. This can result in significant usage of computing resources, which can increase power consumption, reduce device performance, and can increase output latency. Furthermore, greater computing resource utilization may require specialized or more capable computing hardware, restricting the types of applications for attention-based ML techniques.

Additionally, dividing by an L2 norm in determining attention weights introduces the risk of divide-by-zero errors. To address this, conventional systems may add an E value to the denominator when determining attention weights. These e values may be equivalent to the smallest number possible for a given numerical format, but may still introduce nontrivial numerical instability (such as when the features being attended to are small in value). Accordingly, techniques that rely on e values may experience greater output inaccuracies.

One solution to these problems is to reduce or remove multiplication steps through improved computation of the differences and/or attention weights. For example, differences may be determined between corresponding elements of query and key values and establishing attention weights based on these differences. To reduce computation complexity, the attention weights may be computed based on L1 differences between the values, L2 differences between the values, or a combination thereof. Such implementations may reduce the total number of multiplication steps required. To further improve performance, rather than directly calculating these values, a computing device may be configured to access these values from a lookup table based on the computed differences, which may completely remove the requirement to perform a multiplication step. Further, to reduce the computational complexity of normalization, the differences may be normalized based on the size of a vector containing the input data, rather than having to perform a separate softmax step.

Particular implementations of the subject matter described in this disclosure may be implemented to realize one or more of the following potential advantages or benefits. The described techniques provide significant benefits by reducing the computational complexity of attention mechanisms in machine learning calculations. The present techniques reduce computing resource utilization and power consumption by decreasing the number of multiplication steps between query values and key values needed to determine attention weights. This reduction may not only conserve resources but may also enable faster response times and reduced latency in processing input and output data, which may be particularly beneficial for real-time applications like, natural language processing, self-driving vehicles, real-time video manipulation, and the like. Additionally, these techniques may reduce or eliminate the risk of divide-by-zero errors often encountered in related techniques, improving numerical stability without requiring ∈ values. Importantly, experimental results demonstrate that these efficiency improvements do not compromise accuracy within machine learning models that are trained to utilize the described attention mechanisms. Further, these techniques allow for compatibility with less-specialized hardware by removing multiplication steps that often require larger bit width channels to function.

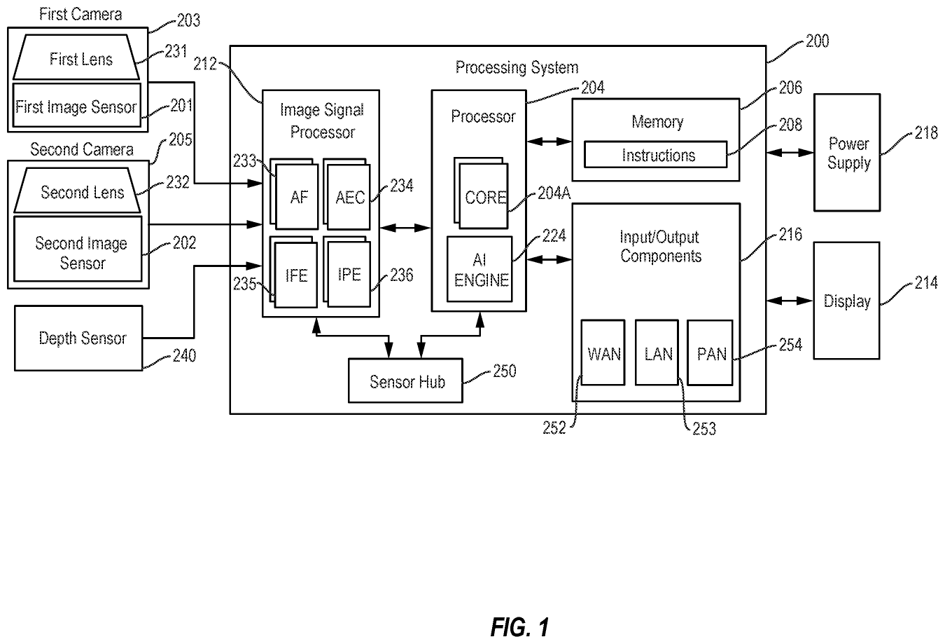

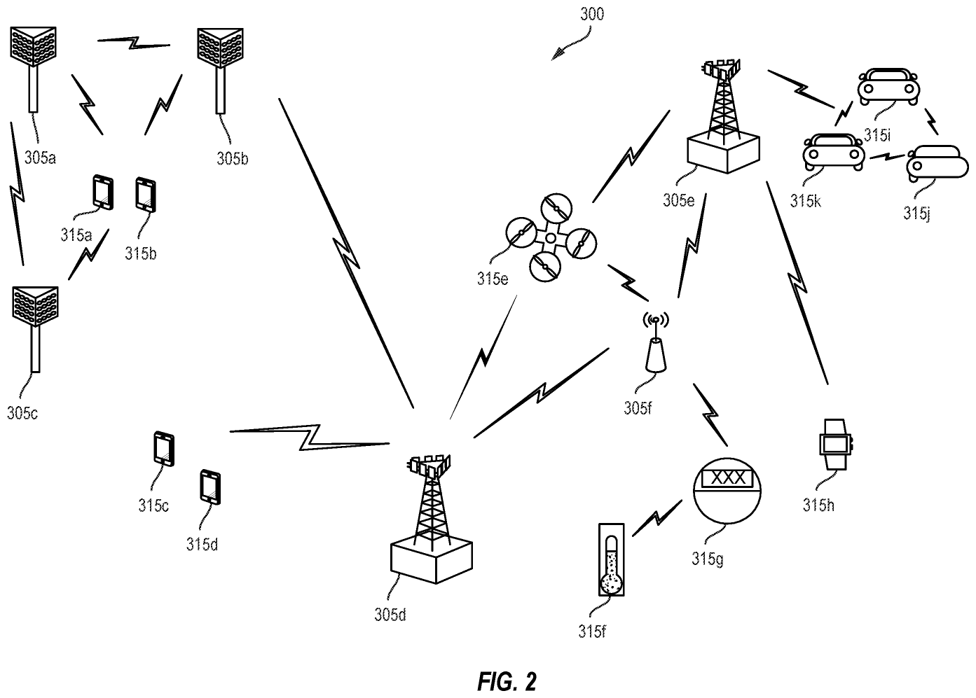

FIG. 1 shows a block diagram of an example processing system 200 according to one or more aspects of the disclosure. The processing system 200 may include, or otherwise be coupled to, an image signal processor 212 for processing image frames from one or more image sensors, such as a first image sensor 201, a second image sensor 202, and a depth sensor 240. In some implementations, the processing system 200 also includes or is coupled to a processor (e.g., CPU) 204 and a memory 206 storing instructions 208. The processing system 200 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other computing devices, mobile devices, vehicles, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The processing system 200 may further include or be coupled to a power supply 218, such as a mains power supply, a battery, and the like. The processing system 200 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The processing system 200 may include a sensor hub 250 for interfacing with and/or receiving data from sensors (such as non-camera sensors). One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203 and second camera 205, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

Each of the cameras 203, 205 may include one, two, or more image sensors 201, 202. For example, the camera 203 may include a first image sensor 201 and a second image sensor (not depicted). When multiple image sensors are present, the first image sensor 201 may have a larger field of view (FOV) than the second image sensor or the first image sensor 201 may have different sensitivity or different dynamic range than the second image sensor. In one example, the first image sensor 201 may be a wide-angle image sensor, and the second image sensor may be a telephoto image sensor. In another example, the first image sensor 201 is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view. Although the example discussed above focused on the first camera 203, the second camera 205 may be configured using one or more of the configurations discussed above (such as with a first image sensor 202 and a second image sensor (not depicted)).

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the processing system 200 for generating images or videos. The instructions 208 may also include other applications or programs executed for the processing system 200, such as an operating system, mapping applications, or entertainment applications. Execution of the camera application, such as by the processor 204, may cause the processing system 200 to generate images using the image sensors 201 and 202 and the image signal processor 212. The memory 206 may also be accessed by the image signal processor 212 to store processed frames or may be accessed by the processor 204 to obtain the processed frames. In some embodiments, the processing system 200 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, image processing, natural language processing, text generation, risk map generation, driver monitoring, driver alert operations, and the like. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206. In executing the camera application, the processor 204 may be configured to instruct the image signal processor 212 to perform one or more operations with reference to the image sensors 201, 202, as discussed above.

In some embodiments, the processor 204 may include ICs or other hardware (e.g., an artificial intelligence (AI) engine 224) in addition to the ability to execute software to cause the processing system 200 to perform a number of functions or operations, such as the operations described herein. In some other embodiments, the processing system 200 does not include the processor 204, such as when all of the described functionality is configured in the image signal processor 212. In particular embodiments, the processor 204 and/or another processor of the processing system 200 may include a machine learning processor. Machine learning processors may include one or more processing units tailored for operating/manipulating machine learning data/features structures (e.g., tensors), executing machine learning algorithms, or a combination thereof. A first example machine learning processor includes Neural Processors (NPs), hardware components specifically designed to perform calculations necessary for artificial neural networks, leveraging parallel processing capabilities to handle complex computational tasks efficiently. A second example machine learning processor includes Hardware-Based Machine Learning Accelerators (MLAs) that enhance the speed of machine learning applications by optimizing the underlying hardware for specific machine learning algorithms (such as for particular types of computing operations). A third example machine learning processor may include an machine learning (ML) core within a CPU, which may be embedded in a traditional CPU and may be specifically optimized to accelerate machine learning workloads or computations. A fourth example machine learning processor may include Neural Signal Processors (NSPs) and/or Neural Processing Units (NPUs) are other types of processors that are designed for optimized performance with neural network-based workloads.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the processing system 200 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the processing system 200.

The processing system 200 may communicate as a user equipment (UE) within a wireless network 300, such as through WAN adaptor 252, as shown in FIG. 2. FIG. 2 is a block diagram illustrating details of an example wireless communication system according to one or more aspects. Wireless network 300 may, for example, include a 5G wireless network. As appreciated by those skilled in the art, components appearing in FIG. 2 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

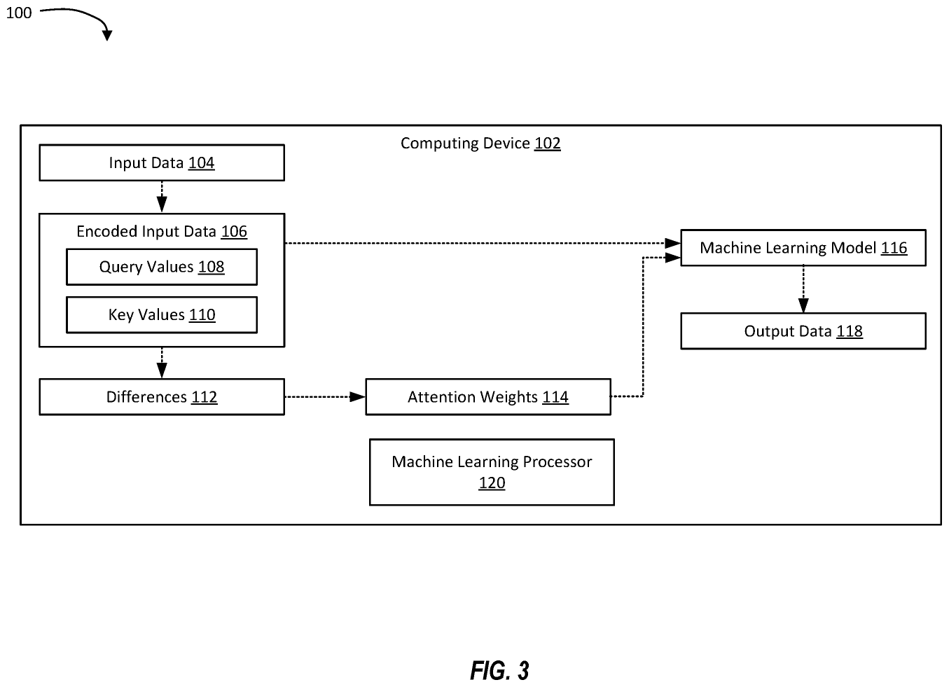

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315i-k are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305e.

Aspects of the systems described with reference to, and shown in, FIGS. 1 and 2 may include determining attention weights for use in determining machine learning outputs. In particular, attention weights may be determined to reduce or remove multiplication steps.

FIG. 3 is a block diagram illustrating a system 100 for determining attention-based machine learning outputs according to one or more aspects of the present disclosure. The system 100 includes a computing device 102. The computing device 102 includes a machine learning model 116, a machine learning processor 120, input data 104, encoded input data 106, differences 112, attention weights 114, and output data 118. The encoded input data 106 includes query values 108 and key values 110. The system 100 may be an exemplary implementation of the system 200. For example, the computing device 102 may be an exemplary implementation of the processing system 200. As noted above, machine learning processors (such as the machine learning processor 120) may be implemented as one or more of a neural processor, a hardware-based machine learning accelerator, a machine learning core within a CPU, an NSP, an NPU, and the like.

The computing device 102 may be configured to receive encoded input data 106 for a machine learning model 116. In certain implementations, the computing device 102 may receive input data 104 and may determine the encoded input data 106 based on the received input data 104. The input data 104 may include data received from (such as directly or indirectly from) one or more sensors, image sensors, users, databases, other computing devices, and the like. In certain implementations, the encoded input data 106 may be quantized into one or more data formats (such as floating point numbers, 4-bit integers, 8-bit integers, 16-bit integers, and the like). In certain implementations, the computing device may be configured to utilize encoded input data 106 with an arbitrary quantization (such as 5-bit integers, 3-bit integers, and the like). Such implementations may be utilized in implementations where the computing device 102 includes or is configured to utilize application specific integrated circuit (ASIC) hardware. In certain implementations, the encoded input data 106 may have a different quantized format than the input data 104. In such implementations, the input data 104 may be quantized before determining the encoded input data 106. In additional or alternative implementations, encoded input data 106 may be quantized after being determined based on the input data 104. In particular implementations, the encoded input data 106 may be quantized in one of a 4-bit integer format or an 8-bit integer format.

In certain implementations, the encoded input data 106 may include query values 108 and key values 110. For example, the encoded input data 106 may be encoded according to a query, key, value (QKV) process, similar to the QKV processing discussed above. In certain implementations, the QKV process may be trained or otherwise associated with the machine learning model 116. In certain implementations, the input data 104 may be tokenized and embedded, and the embeddings/feature vectors may be used to determine the query values 108 and the key values 110.

In certain implementations, the encoded input data 106 may be received from another computing device. For example, a separate computing device (such as a server computing device) may be configured to receive the input data 104 and to determine the encoded input data 106 based on the input data 104 using one or more of the above-discussed techniques.

The computing device 102 may be configured to determine differences 112 between corresponding elements of the query values 108 and the key values 110. The computing device 102 may also be configured to determine attention weights 114 for use by the machine learning model 116 based on the differences 112. In certain implementations, the attention weights 114 are determined to identify an importance of corresponding portions of the encoded input data 106 when determining the output data 118. For example, and as explained above, the attention weights may be used to weight corresponding portions of the encoded input data 106 (such as corresponding tokens/embeddings) when determining a context vector that is then processed by the model 116 to determine the output data 118. In implementations where the input is tokenized, the attention weights 114 may include a corresponding attention weight for each of at least a subset of the tokens in the encoded input data 106.

In certain implementations, the computing device 102 may be further configured to normalize the differences 112, and the attention weights 114 are determined based on the normalized differences. For example, the normalized differences may be determined based on a size of a feature vector for the encoded input data 106 (such as by dividing the differences 112 by the size of feature vectors for the input data 104 to determine the normalized differences).

The attention weights 114 and differences 112 may be uniquely determined to reduce the number of multiplication steps over conventional attention techniques. For example, the attention weights 114 may be determined based on the differences 112 to reduce the number of multiplication steps. As another example, the differences 112 may be determined using techniques that reduce the number of multiplication steps.

In certain implementations, the differences 112 may be determined based on L2 differences between the corresponding elements of the query values 108 and the key values 110. For example, the differences 112 may be determined as:

$${Diff}_{L 2} = exp ( - \frac{1}{scaler} {‖ {x}_{i} - {y}_{i} ‖}_{2}^{2} ) = exp ( - \frac{1}{scaler} {\sum }_{i} {( {x}_{i} - {y}_{i} )}^{2} )$$

Where ∥xᵢ−yᵢ∥₂ is the L2 norm, X and Y are the query and key values, and scaler is a scaling factor (such as a size of the received feature vectors for the encoded input data 106). When compared to Diff_{CONV1,2}, the computation of Diff_{L2} removes the multiplication steps within the summation/computation, simplifying the computation.

In additional or alternative implementations, the differences 112 are determined based on L1 differences between the corresponding elements of the query values 108 and the key values 110. For example, the differences 112 may be determined as:

$${Diff}_{L 1} = exp ( - \frac{1}{scaler} {‖ {x}_{i} - {y}_{i} ‖}_{1} ) = exp ( - \frac{1}{scaler} {\sum }_{i} \vert {x}_{i} - {y}_{i} \vert )$$

Where ∥xᵢ−yᵢ∥₁ is the L1 norm, X and Y are the query and key values, and norm is a normalization factor (such as a size of the received feature vectors for the encoded input data 106). When compared to Diff_{L2}, the computation of Diff_{L1} further reduces the multiplication steps by removing the squared term from the summation. In certain implementations, the only remaining multiplication term is dividing by scaler, as the exp( ) function may be determined as a summation. In certain implementations, the definition of scaler may differ between Diff_{L2} and Diff_{L1}. In additional or alternative implementations, scaler may be similarly defined (such as a size of the received feature vectors for the encoded input data 106).

In certain implementations, the attention weights 114 are determined without performing multiplication between elements of the query values 108 and the key values 110. For example, the computing device 102 may be configured to determine the attention weights 114 based on predetermined values within a lookup table. The predetermined values may correspond to particular values of differences 112 between the corresponding elements of the query values 108 and the key values 110. In particular, the lookup table may be predetermined to contain values that reflect an L1 difference, and L2 difference, or a combination thereof for corresponding difference values between a query value and its corresponding key value. In such implementations, the computing device 102 may be configured to compute a absolute difference between a query value and its corresponding key value and to lookup a corresponding values within the lookup table. For example, the lookup table may have values based on Diff_{L1}, such as based on differences z, which may be computed as z=Σᵢ|xᵢ−yᵢ|. As another example, the lookup table may have values based on Diff_{L2}, such as based on differences z, which may be computed as z=Σᵢ(xᵢ−yᵢ)². In either of the above implementations, or for other implementations of z, the predefined lookup table values may be determined as:

$${Diff}_{Lookup} = exp ( - \frac{z}{scaler} )$$

where scaler may be defined as discussed above for Diff_{L2} and Diff_{L1}.

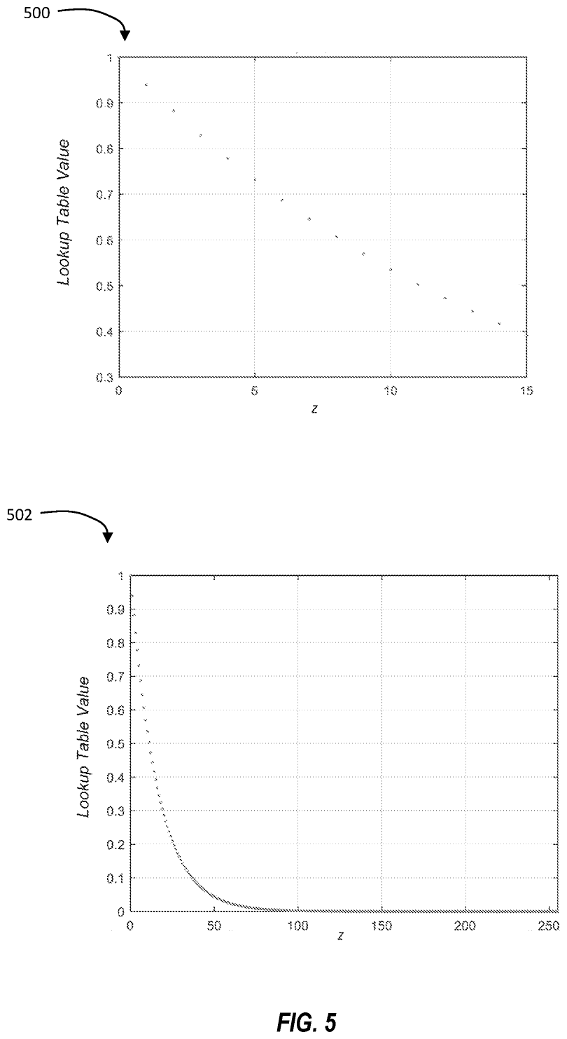

In certain instances, the absolute difference may be normalized (such as based on a vector size) before determining corresponding values within the lookup table. In additional or alternative implementations, values received from the lookup table may be normalized. In still further implementations, the lookup table values may already be normalized (such as for feature vectors with a predetermined size). Example lookup table values are shown in FIG. 5, which depicts graphs 500, 502 of lookup table values for corresponding z values. In particular, graph 500 depicts lookup table values (Diff_{Lookup}) for 4-bit integer values with scaler=16. Graph 502 depicts lookup table values (Diff_{Lookup}) for 8-bit integer values with scaler=256.

As one skilled in the art will appreciate, different formulations of the differences 112 may be utilized from those discussed above. For example, in addition to differences determined based on L1 differences and L2 differences discussed above, the computing device 102 may be configured to determine and utilize differences 112 according to L-infinity norms between the corresponding elements of the query values and the key values. In certain such implementations, L-infinity norms may be advantageous for large feature vectors (such as to reduce processing times for attention weight determination). As another example, the computing device 102 may be configured to determine and utilize differences 112 according to p-norms between the corresponding elements of the query values and the key values. In additional or alternative implementations, the differences 112 may be determined as a combination of one or more of L1 differences, L2 differences, L-infinity norms, and p-norms. Furthermore, it should be noted that the predefined values in the lookup table may be similarly computed according to one or more of L1 differences, L2 differences, L-infinity norms, p-norms, or a combination thereof.

In certain implementations, the lookup table may be prepared for a particular format of the encoded input data 106. For example, the computing device 102 may contain a lookup table for differences of 4-bit quantized encoded input data, a lookup table for differences of 8-bit quantized encoded input data, or a combination thereof. In certain examples, 4-bit quantized input data may require 2⁴=16 entries, each of which is 4 bits in size, resulting in a lookup table that is 8 bytes in size. As another example, 8-bit quantized input data may require 2⁸=256 entries, each of which is 8 bits in size, resulting in a lookup table that is 256 bytes in size.

In certain implementations, the lookup table may be stored at runtime within a memory of the computing device 102 (such as the memory 206). In additional or alternative implementations, the lookup table may be stored within a processor (such as the processor 204, the machine learning processor 120, or a combination thereof). For example, the lookup table may be stored within a cache of the processor. In such implementations, the lookup table may be hard coded or permanently stored within the machine learning processor 120 (such as when creating or manufacturing the processor). In certain limitations, the lookup table values may be accessed using a corresponding instruction within the processor (such as within the machine learning process or 120). For example, a machine learning processor 120 may be configured to utilize the presently described attention mechanisms with a corresponding lookup table that is accessed with a particular lookup construction that received the absolute or normalized difference values. In certain such implementation, the lookup table values may be accessed using a single processor instruction, which represents a significant (5×, 10×, 20×, 50×, 100×, 1000× and the like) reduction in total number of instructions executed when determining the attention weights 114 compared to conventional attention mechanisms that rely extensively on multiplication.

The computing device 102 may be configured to determine, by the machine learning model 116, output data 118 based on the encoded input data 106 and the attention weights 114. In particular, an impact or influence of the encoded input data 106 (such as for individual tokens of the input data 106) may be adjusted or otherwise determined based on the attention weights 114. In particular, tokens with a higher corresponding attention weight may have a greater impact when determining the output data 118 and tokens with a lower corresponding attention weight 114 may have a lower impact when determining the output data 118. The type of output data 118 may depend on the application and the machine learning model 116. In various implementations, the output data 118 may include one or more of object detection information for a received image, processed text, entity identifications, driver monitoring information, vehicle control instructions, and the like.

In certain implementations, the computing device 102 may be further configured to train the machine learning model 116. For example, the computing device 102 may be configured to train the machine learning model 116 based on the attention weights 114, the output data 118, or a combination thereof. For example, the machine learning model 116 may be implemented as a transformer model, a neural network model, or another type of attention-based ML model. The machine learning model 116 may be trained based on training data, which may include input data and expected output data. Parameters of the machine learning model 116 may be updated based on whether the machine learning model 116 generates correct outputs when compared to the expected outputs. In particular, the machine learning model 116 may receive one or more pieces of input data from the training data sets that are associated with a plurality of expected outputs. The machine learning model 116 may generate predicted outputs based on a current configuration of the machine learning model 116. The predicted outputs may be compared to the expected outputs and one or more parameter updates may be computed based on differences between the predicted outputs and the expected outputs. In particular, the parameters may include weights (e.g., priorities) for different features and combinations of features. The parameter updates the machine learning model 116 may include updating one or more of the features analyzed and/or the weights assigned to different features or combinations of features (e.g., relative to the current configuration of the machine learning model 116). In particular, the machine learning model 116 may be trained in order to utilize attention weights determined according to one or more of the above techniques. For example, the machine learning model 116 may be configured to use the above-described attention techniques when determining output data for received training data. In this way, the machine learning model 116 may be configured to utilize the efficient attention mechanisms described herein.

The presently disclosed techniques for attention mechanisms in machine learning calculations may enable multiple benefits for computing devices that are configured to utilize and execute attention-based machine learning models. These techniques may reduce computing resource utilization at run time by reducing the number of multiplication steps between query values and key values that need to be performed by computing devices in order to determine the attention weights. Furthermore, these techniques may correspondingly reduce power consumption based on the reduction of multiplication steps that are performed. Relatedly, these techniques may enable quicker response times and less latency between receiving input data and determining output data for attention-based machine learning models. This may be particularly important in applications (such as self-driving vehicles, vehicle monitoring, real-time video manipulation, and the like) in which such models are used in real time. Furthermore, certain implementations discussed above (such as the lookup table) remove the risk of dividing by zero. Accordingly, e values (discussed above) may not be necessary, enabling higher numerical stability when compared to convention techniques that rely on e values to avoid divide-by-zero errors.

Furthermore, experimental results have demonstrated that the attention weights are comparably accurate when determined using the presently described techniques in comparison to conventional techniques. For example, an EVA Proto DFS Model SceneFlow EPE analysis provided the following scores:

TABLE 2
Comparison Results for Exemplary Implementations
of Described Techniques

| Implementation | Score (Lower is Better) |
|---|---|
| Conventional, Multiplicative Techniques | 0.6613 |
| L2-Based Differences (Computed or | 0.6599 |
| Accessed from a Lookup Table) | |
| L1-Based Differences (Computed or | 0.6630 |
| Accessed from a Lookup Table) | |

Accordingly, these techniques may not sacrifice accuracy in order to achieve the above-described improvements.

Additionally, multiplication-based attention mechanisms may require larger bit width channels (such as 2-bit width) to function. The presently-described techniques may reduce this restriction by removing multiplication steps (such as when using a lookup table). Accordingly, these techniques may improve compatibility with less-specialized hardware (such as processors or channels within a processor that have a 1-bit width).

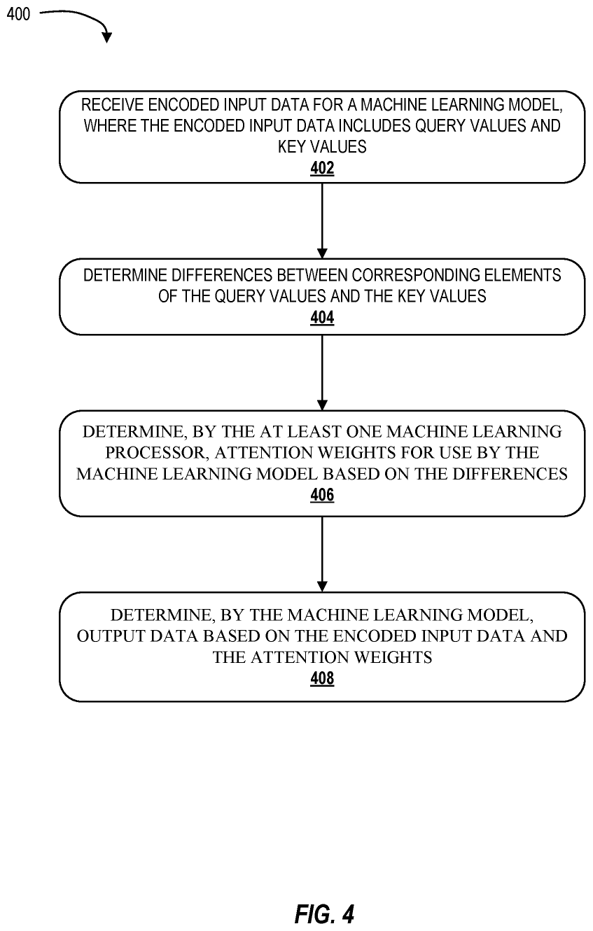

FIG. 4 is a flow chart illustrating an example method 400 for determining attention-based machine learning outputs according to one or more aspects of the present disclosure. The method may be performed by one or more of the above systems, such as the systems 100, 200, 300.

The method 400 includes receiving encoded input data 106 for a machine learning model 116, and the encoded input data 106 may include query values 108 and key values 110 (block 402). For example, the computing device 102 may receive encoded input data 106 for a machine learning model 116, the encoded input data 106 may be tokenized to include query values 108 and key values 110. In certain implementations, the encoded input data 106 may be quantized in one of a 4-bit integer format or an 8-bit integer format.

The method 400 includes determining differences 112 between corresponding elements of the query values 108 and the key values 110 (block 404). For example, the computing device 102 may determine differences 112 between corresponding elements of the query values 108 and the key values 110.

The method 400 includes determining attention weights 114 for use by the machine learning model 116 based on the differences 112 (block 406). For example, the computing device 102 may determine attention weights 114 for use by the machine learning model 116 based on the differences 112. In certain implementations, the attention weights 114 are determined to identify an importance of corresponding portions of the encoded input data 106 when determining the output data 118. In certain implementations, the method 400 may include determining normalized differences 112 based on the differences 112 between the corresponding elements of the query values 108 and the key values 110, the attention weights 114 are determined based on the normalized differences 112. In certain implementations, the normalized differences 112 are determined based on a size of a vector containing the encoded input data 106. In certain implementations, the differences 112 are determined based on L1 differences between the corresponding elements of the query values 108 and the key values 110. In certain implementations, the differences 112 are determined based on L2 differences between the corresponding elements of the query values 108 and the key values 110. In certain implementations, the attention weights 114 are determined without performing multiplication between elements of the query values 108 and the key values 110. For example, the attention weights 114 may be determined based on predetermined values within a lookup table that correspond to the differences 112 between the corresponding elements of the query values 108 and the key values 110. In certain implementations, the predetermined values within the lookup table are determined using a corresponding instruction within a machine learning processor 120 (such as a single instruction for the machine learning processor 120).

The method 400 includes determining, by the machine learning model 116, output data 118 based on the encoded input data 106 and the attention weights 114 (block 408). For example, the computing device 102 may determine, by the machine learning model 116, output data 118 based on the encoded input data 106 and the attention weights 114. In certain implementations, the method 400 may further include training the machine learning model 116 based on the attention weights 114, the output data 118, or a combination thereof.

It is noted that one or more blocks (or operations) described with reference to FIG. 4 may be combined with one or more blocks (or operations) described with reference to another of the figures. For example, one or more blocks (or operations) of FIG. 4 may be combined with one or more blocks (or operations) of FIG. 1-3.

In one or more aspects, techniques for supporting vehicular operations may include additional aspects, such as any single aspect or any combination of aspects described below or in connection with one or more other processes or devices described elsewhere herein.

A first aspect provides a method including receiving encoded input data for a machine learning model, wherein the encoded input data includes query values and key values; determining differences between corresponding elements of the query values and the key values; determining attention weights for use by the machine learning model based on the differences; and determining, by the machine learning model, output data based on the encoded input data and the attention weights.

In a second aspect, according to the first aspect, the attention weights are determined to identify an influence of corresponding portions of the encoded input data when determining the output data.

In a third aspect, according to the first aspect or the second aspect, the attention weights are determined without performing multiplication between elements of the query values and the key values.

In a fourth aspect, according to any of the first aspect through the third aspect, the method further includes determining normalized differences based on the differences between the corresponding elements of the query values and the key values, wherein the attention weights are determined based on the normalized differences.

In a fifth aspect, according to the fourth aspect, the normalized differences are determined based on a size of a feature vector for the encoded input data.

In a sixth aspect, according to any of the first aspect through the fifth aspect, the method further includes determining the attention weights based on predetermined values within a lookup table that correspond to the differences between the corresponding elements of the query values and the key values.

In a seventh aspect, according to the sixth aspect, the encoded input data is quantized in one of a 4-bit integer format or an 8-bit integer format.

In an eighth aspect, according to the sixth aspect or the seventh aspect, the predetermined values within the lookup table are determined using a corresponding instruction within a machine learning processor.

In a ninth aspect, according to any of the first aspect through the eighth aspect, the method further includes training the machine learning model based on the attention weights, the output data, or a combination thereof.

In a tenth aspect, according to any of the first aspect through the ninth aspect, the differences are determined based on at least one of L1 differences between the corresponding elements of the query values and the key values, L2 differences between the corresponding elements of the query values and the key values, L-infinity norms between the corresponding elements of the query values and the key values, p-norms between the corresponding elements of the query values and the key values, or a combination thereof.

An eleventh aspect provides a system including at least one processor, comprising at least one machine learning processor; and a memory storing instructions which, when executed by the at least one processor, cause the at least one processor to receive encoded input data for a machine learning model, wherein the encoded input data includes query values and key values; determine, by the at least one machine learning processor, differences between corresponding elements of the query values and the key values; determine, by the at least one machine learning processor, attention weights for use by the machine learning model based on the differences; and determine, by the machine learning model, output data based on the encoded input data and the attention weights.

In some implementations, the system includes a wireless device, such as a UE. In some implementations, the system may include at least one processor, and a memory coupled to the processor. The processor may be configured to perform operations described herein with respect to the apparatus. In some other implementations, the system may include a non-transitory computer-readable medium having program code recorded thereon and the program code may be executable by a computer for causing the computer to perform operations described herein with reference to the system. In some implementations, the system may include one or more means configured to perform operations described herein. In some implementations, a method of wireless communication may include one or more operations described herein with reference to the system.

In a twelfth aspect, according to the eleventh aspect, the attention weights are determined to identify an influence of corresponding portions of the encoded input data when determining the output data.

In a thirteenth aspect, according to the eleventh aspect or the twelfth aspect, the attention weights are determined without performing multiplication between elements of the query values and the key values.

In a fourteenth aspect, according to any of the eleventh aspect through the thirteenth aspect, the instructions further cause the processor to determine normalized differences based on the differences between the corresponding elements of the query values and the key values, wherein the attention weights are determined based on the normalized differences.

In a fifteenth aspect, according to the fourteenth aspect, the normalized differences are determined based on a size of a feature vector for the encoded input data.

In a sixteenth aspect, according to any of the twelfth aspect through the fifteenth aspect, the system further includes determining the attention weights based on predetermined values within a lookup table that correspond to the differences between the corresponding elements of the query values and the key values.

In a seventeenth aspect, according to the sixteenth aspect, the predetermined values within the lookup table are determined using a corresponding instruction within the machine learning processor.

In an eighteenth aspect, according to the sixteenth aspect or the seventeenth aspect, the encoded input data is quantized in one of a 4-bit integer format or an 8-bit integer format.

In a nineteenth aspect, according to any of the eleventh aspect through the eighteenth aspect, the differences are determined based on at least one of L1 differences between the corresponding elements of the query values and the key values, L2 differences between the corresponding elements of the query values and the key values, L-infinity norms between the corresponding elements of the query values and the key values, p-norms between the corresponding elements of the query values and the key values, or a combination thereof.

A twentieth aspect includes a non-transitory, computer-readable medium storing instructions which, when executed by a processor, cause the processor to receive encoded input data for a machine learning model, wherein the encoded input data includes query values and key values; determine differences between corresponding elements of the query values and the key values; determine attention weights for use by the machine learning model based on the differences; and determine, by the machine learning model, output data based on the encoded input data and the attention weights.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method comprising:
receiving encoded input data for a machine learning model, wherein the encoded input data includes query values and key values;
determining differences between corresponding elements of the query values and the key values;
determining attention weights for use by the machine learning model based on the differences; and
determining, by the machine learning model, output data based on the encoded input data and the attention weights.

2. The method of claim 1, wherein the attention weights are determined to identify an influence of corresponding portions of the encoded input data when determining the output data.

3. The method of claim 1, wherein the attention weights are determined without performing multiplication between elements of the query values and the key values.

4. The method of claim 1, further comprising determining normalized differences based on the differences between the corresponding elements of the query values and the key values, wherein the attention weights are determined based on the normalized differences.

5. The method of claim 4, wherein the normalized differences are determined based on a size of a feature vector for the encoded input data.

6. The method of claim 1, further comprising determining the attention weights based on predetermined values within a lookup table that correspond to the differences between the corresponding elements of the query values and the key values.

7. The method of claim 6, wherein the encoded input data is quantized in one of a 4-bit integer format or an 8-bit integer format.

8. The method of claim 6, wherein the predetermined values within the lookup table are determined using a corresponding instruction within a machine learning processor.

9. The method of claim 1, further comprising training the machine learning model based on the attention weights, the output data, or a combination thereof.

10. The method of claim 1, wherein the differences are determined based on at least one of L1 differences between the corresponding elements of the query values and the key values, L2 differences between the corresponding elements of the query values and the key values, L-infinity norms between the corresponding elements of the query values and the key values, p-norms between the corresponding elements of the query values and the key values, or a combination thereof.

11. A system comprising:
at least one processor, including at least one machine learning processor; and
a memory storing instructions which, when executed by the at least one processor, cause the at least one processor to:
receive encoded input data for a machine learning model, wherein the encoded input data includes query values and key values;
determine, by the at least one machine learning processor, differences between corresponding elements of the query values and the key values;
determine, by the at least one machine learning processor, attention weights for use by the machine learning model based on the differences; and
determine, by the machine learning model, output data based on the encoded input data and the attention weights.

12. The system of claim 11, wherein the attention weights are determined to identify an influence of corresponding portions of the encoded input data when determining the output data.

13. The system of claim 11, wherein the attention weights are determined without performing multiplication between elements of the query values and the key values.

14. The system of claim 11, further comprising determining normalized differences based on the differences between the corresponding elements of the query values and the key values, wherein the attention weights are determined based on the normalized differences.

15. The system of claim 14, wherein the normalized differences are determined based on a size of a feature vector for the encoded input data.

16. The system of claim 12, further comprising determining the attention weights based on predetermined values within a lookup table that correspond to the differences between the corresponding elements of the query values and the key values.

17. The system of claim 16, wherein the predetermined values within the lookup table are determined using a corresponding instruction within the machine learning processor.

18. The system of claim 16, wherein the encoded input data is quantized in one of a 4-bit integer format or an 8-bit integer format.

19. The system of claim 11, wherein the differences are determined based on at least one of L1 differences between the corresponding elements of the query values and the key values, L2 differences between the corresponding elements of the query values and the key values, L-infinity norms between the corresponding elements of the query values and the key values, p-norms between the corresponding elements of the query values and the key values, or a combination thereof.

20. A non-transitory, computer-readable medium storing instructions which, when executed by a processor, cause the processor to:
receive encoded input data for a machine learning model, wherein the encoded input data includes query values and key values;
determine differences between corresponding elements of the query values and the key values;
determine attention weights for use by the machine learning model based on the differences; and
determine, by the machine learning model, output data based on the encoded input data and the attention weights.
